(19) United States
(12) Patent Application Publication
(10) Pub. No.: US 2021/0014324 A1
(43) Pub. Date: Jan. 14, 2021

(54) CACHE AND MEMORY CONTENT MANAGEMENT

(71) Applicant: Intel Corporation, Santa Clara, CA (US)

(72) Inventors: Andrey CHILIKIN, Limerick (IE); Tomasz KANTECKI, Ennis (IE); Chris MACNAMARA, Limerick (IE); John J. BROWNE, Limerick (IE); Declan DOHERTY, Clondalkin (IE); Niall POWER, Newcastle West (IE)

(21) Appl. No.: 17/031,659

(22) Filed: Sep. 24, 2020

(51) Int. Cl. H04L 29/08; H04L 12/24; H04L 12/26; G06F 12/0862; G06F 1/28

(52) U.S. Cl. CPC H04L 67/2847; H04L 41/0803; G06F 2212/602; G06F 12/0862; G06F 1/28; H04L 43/16

(57) ABSTRACT

Examples described herein relate to a network interface apparatus that includes an interface; circuitry to determine whether to store content of a received packet into a cache or into a memory, at least during a configuration of the network interface to store content directly into the cache, based at least in part on a fill level of a region of the cache allocated to receive copies of packet content directly from the network interface; and circuitry to store content of the received packet into the cache or the memory based on the determination, wherein the cache is external to the network interface. In some examples, the network interface is to determine to store content of the received packet into the memory based at least in part on a fill level of the region of the cache being identified as full or determine to store content of the received packet into the cache based at least in part on a fill level of the region of the cache being identified as not filled. In some examples, the network interface is to indicate a complexity level of content of the received packet to cause adjustment of a power usage level of a processor that is to process the content of the received packet.

Intel® Data Direct I/O (DDIO) is an input/output (I/O) protocol that enables a sender device (e.g., network interface card (NIC) or computing platform) to send data to a receiver NIC to copy into a cache level such as the last level cache (LLC) without having to first copy the data to main memory and then to LLC. Using DDIO, as packets are received, packets are written directly to L3 cache where a networking application can poll the queues and process the received network packets. Intel® DDIO technology has accelerated network workloads greatly by allowing network interfaces to access Level 3 (L3) cache directly thereby reducing time consuming operations of accessing dynamic random-access memory (DRAM) memory.

### BRIEF DESCRIPTION OF THE DRAWINGS

FIG. 1 depicts an example manner of performing a cache write operation from a network interface card.

FIG. 2A depicts an example manner of copying packets received by a network interface card (NIC) to a destination cache.

FIG. 2B depicts an example manner of copying packets received by a network interface card.

FIG. 3A depicts an example system that includes a network interface card and host system.

FIG. 3B depicts an example of a packet director in accordance with various embodiments.

FIG. 4A depicts an example process.

FIG. 4B depicts an example system.

FIG. 5 shows an example descriptor with packet complexity indicator.

FIG. 6 depicts an example process.

FIG. 7 depicts a system.

FIG. 8 depicts an example environment.

### DETAILED DESCRIPTION

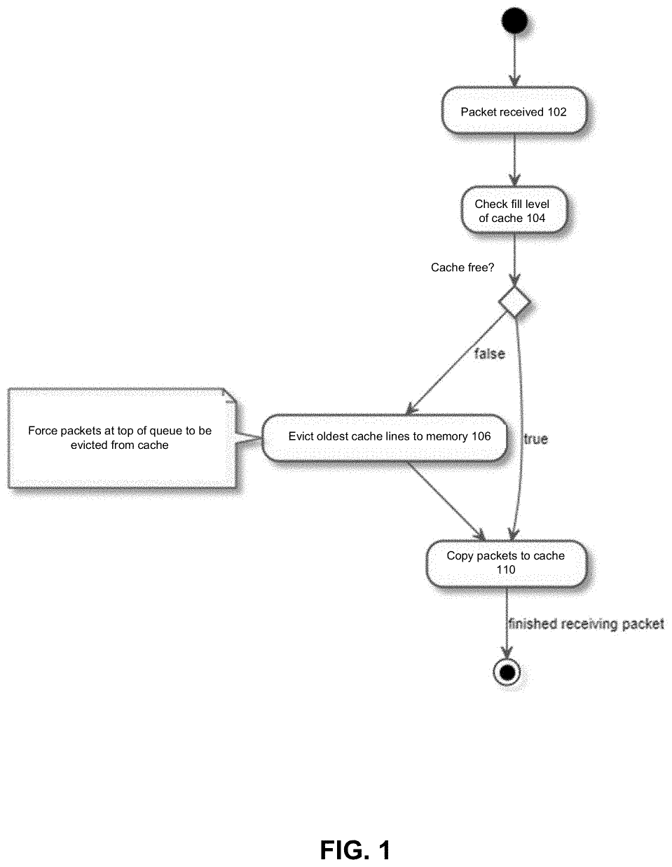

FIG. 1 depicts an example manner of performing a cache write operation from a network interface card. For example, at 102, a packet can be received at a network interface card. In this example, the network interface card is configured to copy contents of the received packet to a destination cache instead of to system memory. For example, the network interface card can utilize DDIO technology. At 104, the network interface card can check a fill level of the destination cache (e.g., last level cache (LLC)) to determine whether the cache is too filled that the cache cannot store additional packet content. If the cache is filled to a level that content of the received packet cannot be stored in the cache, at 106, content of the cache line or lines of the cache stored a longest amount of time can be evicted or copied to system memory (e.g., dynamic random access memory (DRAM)) and the cache line or lines can be made available to store other content. For example, at 106, packet content stored at a top of queue, received earlier in time, can be evicted from the cache.

If the destination cache is not filled to a level so that content of the received packet can be stored in the cache, at 110, content of the received packet can be stored into the destination cache. For example, the content of the received packet can be stored in the cache line or lines whose content was evicted to system memory. For example, the network interface card can copy content of the received packet by direct memory access (DMA) to the destination cache.

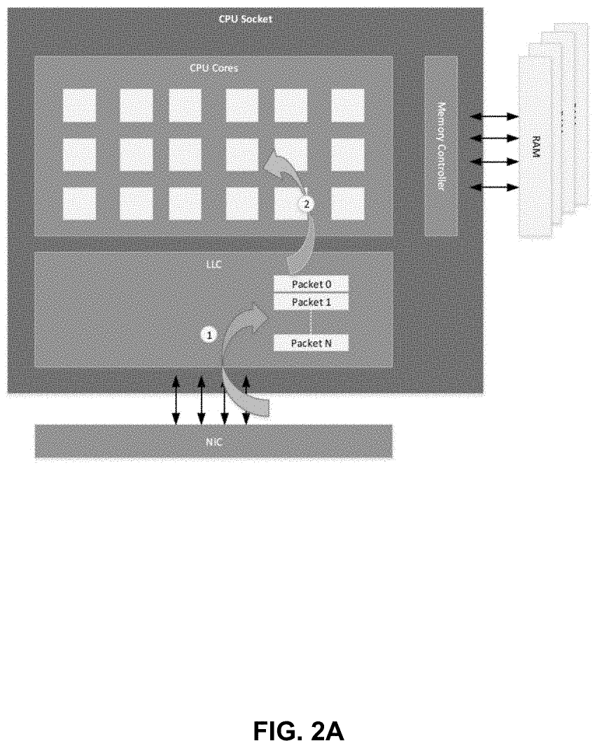

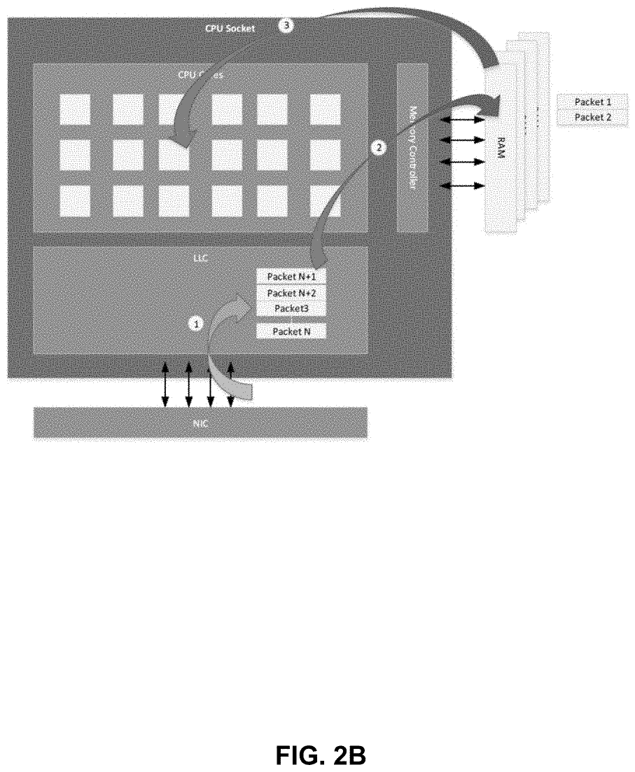

FIG. 2A depicts an example manner of copying packets received by a network interface card (NIC) to a destination cache. In this example, the NIC is configured to copy portions of received packets directly to cache. At step 1, packets are received by the NIC and copied (e.g., by DMA) to a region in L3 cache (or LLC) that was previous allocated by a software application executing on CPU cores to receive the packets. The packets can be aligned in memory as a queue or buffer to store a portion of a received packet. At step 2, the software application polls the queue to retrieve a received packet to process. The software application can process packets in order of arrival such as the first packet identified in the queue (e.g., top of the queue).

In cases where an application is interrupted by another process running on the system, halted by servicing an interrupt or kernel system call, or stalled by a Kernel-based Virtual Machine (KVM) or VMware hypervisor layer, the application can stall but the network interface card can continue to receive packets for processing by the application and copy the received packets into cache. The cache can fill up with arriving packets or data while the interruption is handled. In this scenario, DDIO allows inbound input/output (I/O) (e.g., packets or data from a network interface) to use up a limited portion of the L3 cache, however, other implementations may provide other limits on L3 cache usage or no limits. If this limit is exceeded, new inbound I/O can continue to be written directly to L3 cache, but the least-recently used I/O can be evicted from cache and written to memory to make space for the newly received I/O in L3 cache. In a case where the workload software or polling application is suspended for a sufficient period of time, a DDIO miss can occur and data can be evicted from the cache, evicting packets at the top of the received queue.

Servicing interrupts can disrupt operations of cores. For example, cores can stop their operations in order to execute a kernel thread to handle the interrupts. In a Network Function Virtualization (NFV) environment, an interrupt can cause interruptions to all applications, even those that are not directly affected. For cores that execute packet processing operations, interrupts can introduce packet processing latency to latency critical applications such as 5G Base Station and high speed gateways. Stopping and resuming the operation of processing involves time-intensive acts of saving a state of a currently-executing process to a stack, reloading the state, and resuming operation of the process. Accordingly, interrupting a process delays its completion. When an interrupted application resumes, it may encounter a cache miss as the first packet it is to process is packet at the “top” of the queue, but that packet may have been evicted from the cache and stored to memory. This can cause a significant latency penalty for applications recovering from a stall. Latency of processing the packets can arise from servicing the interrupt and the interrupted application requesting received packet data from memory to be copied to cache. The interrupted application may not be able to process the backlog of waiting received packets and newly received fast enough, according to an applicable service level agreement (SLA).

FIG. 2B depicts an example manner of copying packets received by a network interface card (NIC). In this example, the NIC is configured to copy portions of received packets directly to cache by use of DDIO. At step 1, packets are received by the NIC and copied directly to L3 cache. The processor executing the application could experience an interrupt. At step 2, as the L3 cache area allocated for DDIO is full, content of the cache lines which were least-recently used (or store content that is the oldest) are evicted to make room for the content from the newly received packets. In some examples, packets at the top of the queue are evicted from the L3 cache to system memory (e.g., DRAM). At step 3, after the application resumes operation following the interrupt, the application can attempt to read packets at the top of the queue but encounters a L3 cache miss as the packets were evicted to system memory. The application may experience latency at least from incurring a cache miss and also loading packet content from system memory into L3 cache.

Various embodiments provide for a cache to not evict packets or data from the I/O queues in cache and instead write newly received packets or data directly to system memory (e.g., any version of Double Data Rate (DDR) random access memory (RAM)) when a region of the L3 cache, allocated to receive packet content (or other content) from a network interface card, is full or has reached or exceeded its limit. In some embodiments, when an area of cache allocated to receive packet content (or other content) from a network interface card (e.g., by use of DDIO), rather than a system evicting packet content from the area of the L3 cache or evicting other content from the L3 cache, the network interface card can copy content of newly received packets or data to memory rather than to cache. According to some embodiments, packets at the top of a queue (e.g., higher priority packets, packets were received latest in time, or packets that are to be processed first) can be stored and kept in L3 cache, thereby reducing the latency of data processing by interrupted applications after resuming processing or a non-interrupted applications. According to some embodiments, data processing latency reduction can be achieved by use of a pre-fetcher that can pre-fetch packets or data at the bottom of the queue (e.g., newer received packets or lower priority packets) from memory and store pre-fetched packets or data to cache so that packets or data are stored in the cache and available for processing by the application. Various embodiments described herein can apply to any device including network interface card, accelerator, graphics processing unit, media (e.g., video or audio) encoder or decoder, and so forth.

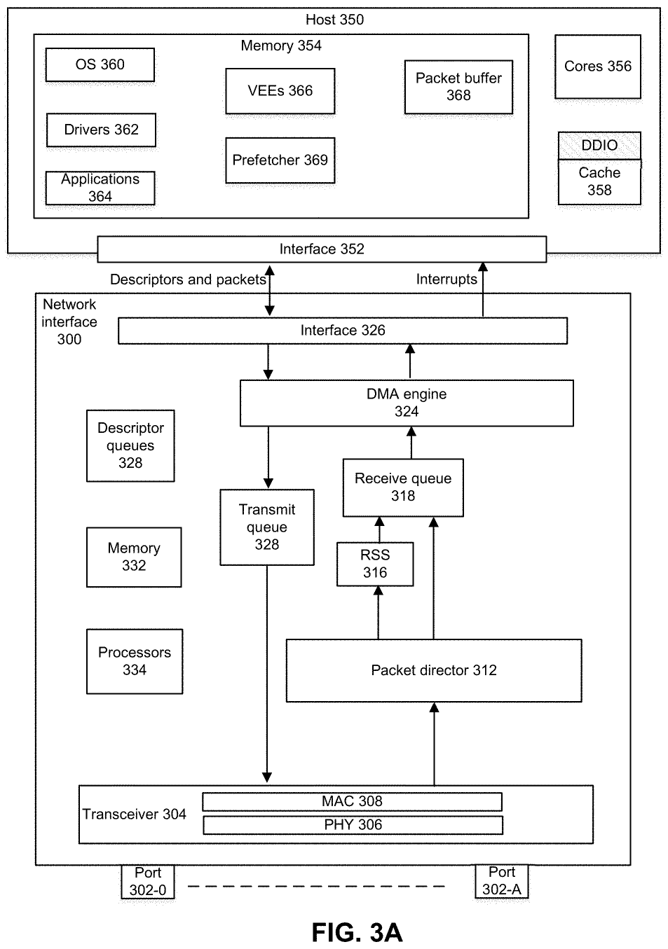

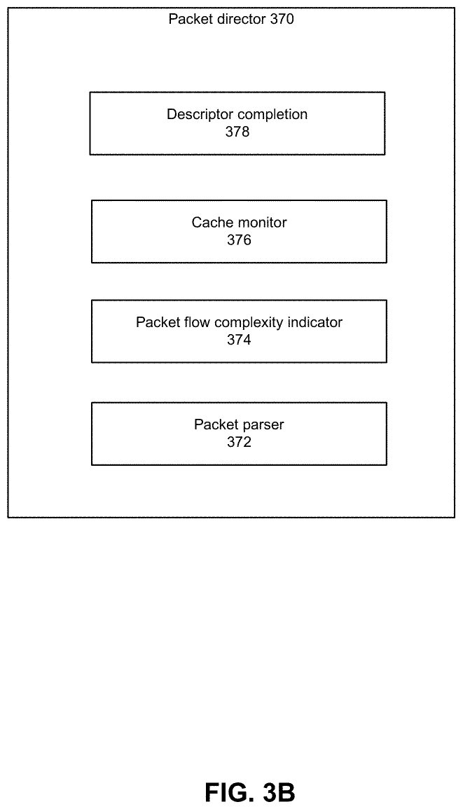

FIG. 3A depicts an example system that includes a network interface card and host system. Network interface card (NIC) 300 can include one or more ports 302-0 to 302-A, where A is an integer and a port can represent a physical port or virtual port. In some embodiments, the NIC 300 may be embodied as part of a system-on-a-chip (SoC) that includes one or more processors, or included on a multichip package that also contains one or more processors. NIC 300 can refer to a network interface, fabric interface, or any interface to a wired or wireless communications medium. A packet received at a port 302-0 to 302-A can be provided to transceiver 304. Transceiver 304 can provide for physical layer processing 306 and media access control (MAC) layer processing 308 of received packets. Physical layer processing 306 and MAC layer processing 308 can receive ingress packets and decode data packets according to applicable physical layer specifications or standards and perform MAC address filtering on received packets, disassemble data from received packets, and perform error detection.

Packet director 312 can inspect a received packet and determine characteristics of the received packet. For example, packet director 312 can determine a TCP flow or characteristics of the received packet or packet to transmit. The TCP flow or characteristics of the received packet or packet to transmit can be one or more of: destination MAC address, IPv4 source address, IPv4 destination address, portion of a TCP header, Virtual Extensible LAN protocol (VXLAN) tag, receive port, or transmit port. Packet director 312 can determine a flow of a received packet. A flow can be a sequence of packets being transferred between two endpoints, generally representing a single session using a known protocol. Accordingly, a flow can be identified by a set of defined N tuples and, for routing purpose, a flow can be identified by tuples that identify the endpoints, e.g., the source and destination addresses. For content based services (e.g., load balancer, firewall, intrusion detection system etc.), flows can be identified at a finer granularity by using five or more tuples (e.g., source address, destination address, IP protocol, transport layer source port, and destination port). A packet in a flow is expected to have the same set of tuples in the packet header.

Packet director 312 can perform receive flow steering to direct traffic flows to certain cache lines in cache 358 or DRAM 354 based on fullness level of cache 358. In some examples, packet director 312 can direct packets for access by applications or devices with lower latency requirements or data path packets to a queue in cache 358 or direct best effort or control plane packets to memory 354 regardless of whether packets in the flow are to be copied to cache 358 by use of DDIO or not. For example, control plane packets can configure a network device (e.g., network interface card, switch, or router) with a routing table that defines how to handle incoming packets (e.g., drop, forward, and so forth). Various embodiments can eliminate or reduce workload-dependent latency variability (jitter) for low latency packet processing applications.

As used herein, DDIO can refer to any scheme that permits a device to write directly to a region of a cache such as permitting a network interface card to write packet content directly to a region of cache that includes one or more cache lines that are allocated to receive packet content. In some examples, when DDIO is enabled, received packets from a remote direct memory access (RDMA)-capable network interface card are written into last level cache (LLC) (also called L3) directly, instead of into memory. For example, DDIO rights that enable NIC 300 to copy content to cache 358 can be set in NIC 300 or set in a root complex. For example, a root complex can connect a processor and memory subsystem to one or more devices enabled to communicate in accordance with PCIe. The root complex can enable one or all PCIe devices to directly write to cache 358 or disable one or all PCIe devices to directly write to cache 358. In some examples, a direct copy of data or content of a packet from a network interface card to a cache can involve copying the data or content to cache as opposed to memory and then from memory to cache.

In some examples, as a condition to permitting a copy of packet content to cache 358 to perform a DDIO operation, NIC 300 can verify a checksum or other properties of the received packet or its content.

In some examples, software running on any of cores 356 or a caching agent (CA) (not shown) can configure NIC 300 to send a portion of a received packet to memory 354 instead of to cache 358 if a portion of cache 358 allocated to receive portions of received packets is filled to a limit level. In some examples, a cache fill level can refer an amount of valid unconsumed or unprocessed data previously transferred into the cache. In some examples, a cache fill level can identify a level or number of unprocessed packets stored in a DDIO-allocated portion of cache 358. In some examples, a level or number of unprocessed packets stored in a DDIO-allocated portion of cache 358 can include an indication of a backlog of unprocessed packets (e.g., including packets stored in any portion of a cache or that are not stored in any portion of a cache). The cache fill level can include a level of pinned content in DDIO-allocated portion of cache 358 (e.g., not permitted to be evicted) and a level of unprocessed packets stored in a DDIO-allocated portion of cache 358. In some examples, a CPU (e.g., software executed on one or more cores 356) can check a fill level of a DDIO-allocated portion of cache 358 and based at least on the fill level being considered full, and/or other factors described herein, determine to copy content to memory 354 instead of cache 358 despite NIC 300 being configured to copy packet content directly to a DDIO-allocated portion of cache 358.

In some examples, a CLDEMOTE instruction or other instruction or process can be used that identifies content of cache (e.g., by address) that are to be demoted or moved from a cache closest to a processor core to a level more distant from the processor core. For example, the demotion instruction can be used to demote content of a DDIO-allocated portion of cache 358 to a non-DDIO allocated portion of cache 358 or to a more distant level of cache (e.g., from L1 to L2, L3, or LLC or from L2 to L3 or LLC).

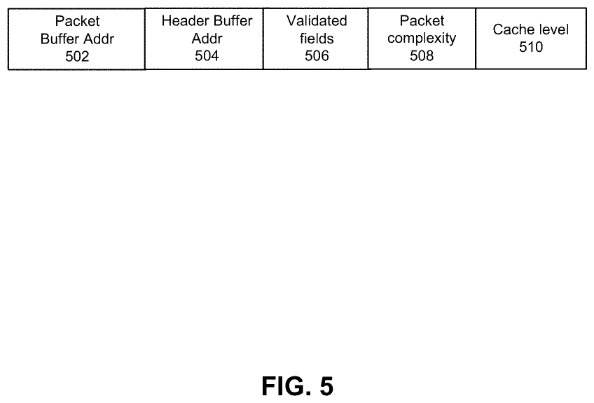

For example, if a portion of cache 358 allocated to receive content of packets in a DDIO operation has not been accessed and a fullness level of the portion of cache 358 is growing or hits a threshold (e.g., 80% or other percentage), then packet director 312 can direct content of received packets to be copied to memory 354 instead of to the portion of cache 358, even if content of the received packets are identified to be copied to cache 358 by application of DDIO. For example, if a portion of cache 358 allocated to receive content of packets in a DDIO operation has been accessed and a fullness level of the portion of cache 358 is shrinking or hits a lower threshold (e.g., 30% or other percentage), then packet director 312 can direct content of received packets to be copied to cache 358, such as when content of the received packets are identified to be copied to cache 358 by application of DDIO. For example, a state of data in cache 358 can indicate whether a cache line has been read/modify or not read and the state of data can be stored in an LLC subsystem, caching agent (CA), or caching and home agent (CHA). Any of cores 356 can write to a control register of a PCIe configuration space of NIC 300 or indicate in a packet receive descriptor whether a portion of cache 358 allocated to receive content of packets in a DDIO operation has been accessed and a fullness level of the DDIO-allocated portion of cache 358. An example of a packet receive descriptor is described with respect to FIG. 5.

In some examples, reducing likelihood of eviction of older received data from cache 358 can include pinning of such data in cache 358 at least until an application processes the data. Pinning of data can prevent its eviction from cache 358 to memory 354.

In some examples, in addition or alternative to other factors such as frequency (or infrequency) of access of data or fullness level of a DDIO-allocated portion of cache 358, packet director 312 can determine to provide packets directly to a DDIO-allocated portion of cache 358 or packet buffer 368 in memory 354 based on a target core's P-state and/or packet complexity. For example, if a core's P-state indicates the core is running slowly or consumes relatively lower power but the packet is higher complexity and would require more time or power to process, packet director 312 can direct content of higher complexity received packets (to be processed by the core) to be copied to memory 354 instead of to cache 358, even if content of the received packets are designated to be copied to cache 358 by use of DDIO. For example, if a core's P-state indicates the core is running slowly or consumes relatively lower power, packet director 312 can direct content of received packets (to be processed by the core) to be copied to memory 354 instead of to cache 358, even if content of the received packets are designated to be copied to cache 358 by use of DDIO. Providing content of received packets to packet buffer 368 in memory 354 instead of cache 358 may help to alleviate or prevent eviction of content from a DDIO-allocated portion of cache 358 that is being processed relatively slowly as adding packet content to cache 358 may cause eviction of packet content from cache 358. In some examples, the P-state of one or more cores can be indicated to a NIC in a descriptor or other manner such as through a direct connected bus or interface with out of band management signals. For example, a field in a descriptor or other communication can indicate a power consumption state (e.g., P-state) or frequency of operation of one or more cores.

In accordance with various embodiments, packet director 312 can determine whether one or more packets of a flow could utilize additional processing cycles to complete processing of packets and indicate to host 350 to adjust a power usage level or frequency of operation of any of cores 356 that are to process the received packets. For example, power usage level can refer to voltage or current supplied. For example, additional processing cycles can refer to clock cycles or time. For example, tunneled or IPSec packets may require more clock cycles or power to process. In some examples, packet director 312 can be configured to increase a frequency of operation or power use level of any of cores 356 that process received packets that could require relatively more time or power to process. Increasing a frequency of operation or power use level of any of cores 356 that process packets could reduce latency to completion of packet processing and also free-up space in cache 358 so that contents of cache 358 are not evicted to make space for any newly received packet. If an application does not drain or process content of a DDIO portion of cache 358 fast enough, packet director 312 can cause a change in P-state of a core that runs the application to run faster and cause the DDIO portion of cache 358 to drain faster.

For example, User Datagram Protocol (UDP) over Internet Protocol (IP) packets may require fewer clock cycles or power to process. In some examples, packet director 312 can be configured to decrease a frequency of operation or power use level of any of cores 356 that process packets that could require relatively less time or power to process.

In some examples, an application or driver can configure packet director 312 to identify packets of a particular type or flow and indicate a particular packet types to set a level of power provided to cores 356 for processing the packets of a particular type or flow. In other words, a PTYPE field can define a packet complexity of processing or power expected for use to process a packet. In some examples, packet director 312 can provide a PTYPE in a receive packet descriptor to host 350 to identify the PTYPE of a packet and request adjustment of a power level of the core that is to process the packet.

RSS 316 can calculate a hash value on a portion of a received packet and use an indirection table to determine a receive buffer (e.g., a buffer in packet buffer 368) in memory 354 and associated core in host 350 to process a received packet. RSS 316 can store the received packets into receive queue 318 for transfer to host 350. Packets with the same calculated hash value can be provided to the same buffer.

Direct memory access (DMA) engine 324 can transfer contents of a packet and a corresponding descriptor to a memory region in host. Direct memory access (DMA) is a technique that allows an input/output (I/O) device to bypass a central processing unit (CPU) or core, and to send or receive data directly to or from a system memory. As DMA allows the CPU or core to not manage a copy operation when sending or receiving data to or from the system memory, the CPU or core can be available to perform other operations. Without DMA, when the CPU or core is using programmed input/output, the CPU or core is typically occupied for the entire duration of a read or write operation and is unavailable to perform other work. With DMA, the CPU or core can, for example, initiate a data transfer, and then perform other operations while the data transfer is in progress. The CPU or core can receive an interrupt from a DMA controller when the data transfer is finished. DMA engine 324 can perform DMA coalescing whereby the DMA engine 324 collects packets before it initiates a DMA operation to a queue in host 350. Receive Segment Coalescing (RSC) can also be utilized whereby content from received packets is combined into a packet or content combination. DMA engine 324 can copy this combination to a buffer in memory 354.

Interrupt moderation can be applied to perform an interrupt to inform host system 350 that a packet or packets or references to any portion of a packet or packets is available for processing from a queue. An expiration of a timer or reaching or exceeding a size threshold of packets can cause an interrupt to be generated. An interrupt can be directed to a particular core that is intended to process a packet.

Interface 326 can provide communication at least with host 350 using interface 352. Interface 326 and 352 can be compatible with any standard or specification such as, but not limited to, PCIe, DDR, CXL, or others.

Referring to host system 350, a host system can be implemented as a server, rack of servers, computing platform, or others. In some examples, cores 356 can include one or more of: a core, graphics processing unit (GPU), field programmable gate array (FPGA), or application specific integrated circuit (ASIC). In some examples, a core can be sold or designed by Intel®, ARM®, AMD®, Qualcomm®, IBM®, Texas Instruments®, among others. Memory 354 can be any type of volatile memory (e.g., DRAM), non-volatile memory, or persistent memory. Cores 356 can execute operating system 360, driver 362, applications 364, and/or a virtualized execution environment (VEE) 366. In some examples, an operating system (OS) 360 can be Linux®, Windows®, FreeBSD®, Android®, MacOS®, iOS®, or any other operating system. Driver 362 can provide configuration and use of any device such as NIC 300.

An uncore or system agent (not depicted) can include or more of a memory controller, a shared cache (e.g., LLC 204), a cache coherency manager, arithmetic logic units, floating point units, core or processor interconnects, Caching/Home Agent (CHA), or bus or link controllers. System agent can provide one or more of: direct memory access (DMA) engine connection, non-cached coherent master connection, data cache coherency between cores and arbitrates cache requests, or Advanced Microcontroller Bus Architecture (AMBA) capabilities.

In some examples, as described herein, NIC 300 can store received packets into a DDIO portion of cache 358 or packet buffer 368. In some examples, as described herein, packet content can be evicted from a DDIO portion of cache 358 into packet buffer 368. In some examples, as described herein, packet content can be prefetched by prefetcher 369 into cache 358. According to some embodiments, data processing latency reduction can be achieved by use of prefetcher 369 that can pre-fetch packets or data from memory and store pre-fetched packets or data to cache 358 so that packets or data are stored in cache 358 and available for processing by the application.

In some examples, prefetcher 369 can predict pattern of memory address accesses by an application 364 or VEE 366 and cause copying of content from memory 354 (e.g., buffer 368) to cache 358 for access by an application 364 or VEE 366. For example, prefetcher 369 could cause an oldest packet in packet buffer 368 to be copied to any portion of cache 358 (even outside of a DDIO region of cache 358) when an interrupted application 364 resumes operation or when an application 364 is predicted to access the packet. Prefetcher 369 can be implemented as hardware or software and interact with a system agent or uncore to cause prefetching.

In some examples, as described herein, NIC 300 can direct or request host 350 to adjust a power state of any of cores 356 based at least on complexity of processing a received packet or packets. For example, model specific register (MSR) can include control registers used for program execution tracing, toggling of compute features, and/or performance monitoring. The MSR can include state transitions as defined by Advanced Configuration and Power Interface (ACPI) industry standards (e.g., P-states and C-states). A core or other microprocessor can determine whether to adjust a P-state of a same core or different core based on PTYPE information provided by packet director 312, such as in a receive descriptor.

In some examples, OS 360 can determine a capability of a device associated with device driver 362. For example, OS 360 can receive an indication of a capability of a device (e.g., NIC 300) to perform one or more of: steering of received packets to cache 358 or packet buffer 368, adjustment of power state of a core, prefetching of content from memory 354 (e.g., packet buffer 368). OS 360 can request driver 362 to enable or disable NIC 300 to perform any of the capabilities described herein. In some examples, OS 360, itself, can enable or disable NIC 300 to perform any of the capabilities described herein. OS 360 can provide requests (e.g., from an application 364 or VEE 366) to NIC 300 to utilize one or more capabilities of NIC 300. For example, any of applications 364 can request use or non-use of any of capabilities described herein by NIC 300.

For example, applications 364 can include a service, microservice, cloud native microservice, workload, or software. Any of applications 364 can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in VEEs. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some applications can perform video processing or media transcoding (e.g., changing the encoding of audio, image or video files).

Virtualized execution environment (VEE) 366 can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from each other, allowing virtual machines to run Linux®, Windows® Server, VMware ESXi, and other operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers are not installed like traditional software programs, which allows them to be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

FIG. 3B depicts an example of a packet director in accordance with various embodiments. In some examples, packet director 370 can utilize a packet parser 372 to determine a flow identifier or traffic classification of a received packet. Packet flow complexity indicator 374 can be configured by a host system (e.g., application, driver, or operating system) to indicate a relative power level or time needed to complete processing a packet of a particular type or complexity. The complexity can be associated with a particular flow or traffic class. Cache monitor 376 can indicate a relative fill level of a region of a cache that is to receive packets from a DDIO operation. For example, a system agent or uncore of a host system can indicate the fill level in a receive packet descriptor (see, e.g., cache level 510 of FIG. 5) sent to NIC 300. Descriptor completion 378 can complete a receive packet descriptor to indicate whether a packet is stored into cache or system memory and indicate a packet complexity level (e.g., packet complexity 508 of FIG. 5) in the receive descriptor. Packet director 380 can be implemented as any combination of processor-executed software, a processor, firmware, or hardware.

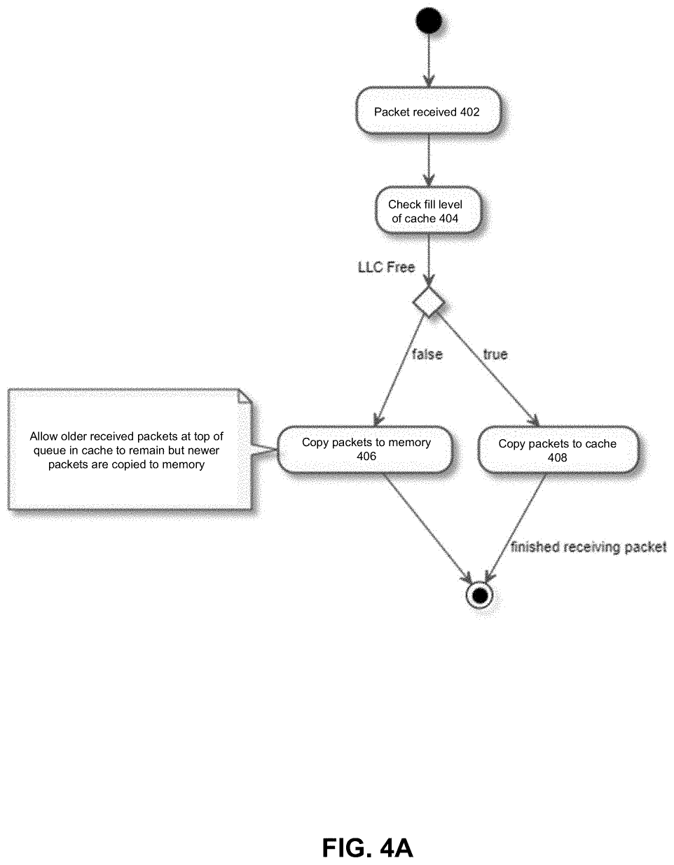

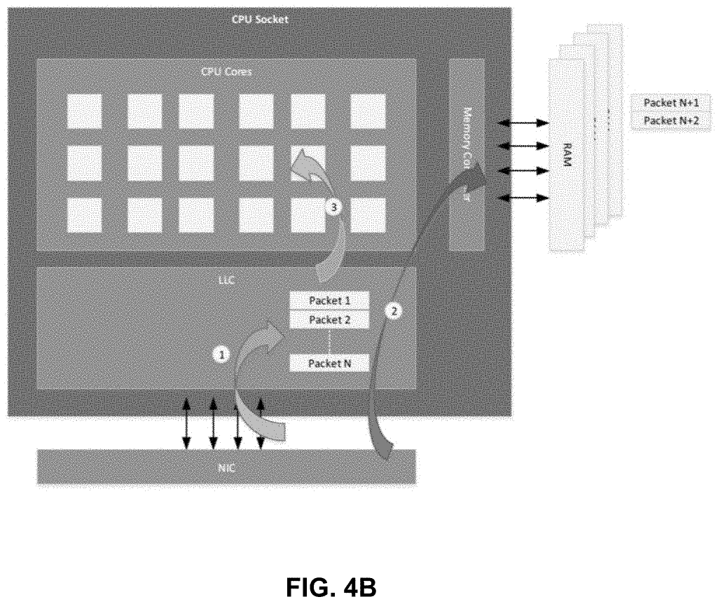

FIG. 4A depicts an example process. For example, at 402, a packet can be received at a network interface card. At 404, the network interface card can determine if the cache is able to receive content of another packet. For example, the network interface card can check a fill level of a portion of a cache (e.g., last level cache (LLC)) allocated for packets copied using DDIO and determine whether the portion is filled to a level that the cache is considered too filled. If the cache is filled to a level that content of the received packet cannot be stored in the cache, at 406, content of the received packet are copied to system memory (e.g., dynamic random access memory (DRAM)) regardless of whether the data is identified to be stored into the cache. If the cache is not filled to a level that content of the received packet cannot be stored in the cache, at 408, content of the received packet are copied to the cache. Accordingly, instead of being evicted to memory, packets at the top of the queue in the cache can be available to be processed.

FIG. 4B depicts an example system. At step 1, a network interface card can receive a packet by the NIC that is to be copied directly to a DDIO region of L3 cache. At step 2, the L3 cache area allocated for DDIO is determined to be full and no packets are evicted from the cache to DRAM. The NIC can copy (e.g., DMA) content of the newly received packet to system memory (e.g., DRAM) instead of to a DDIO region in cache even if the NIC is configured to copy content of the received packet to a DDIO region of cache. In some examples, a packet flow can be identified as to be copied by the NIC to DDIO region of cache. At step 3, when an interrupted application is able to start processing packets again or when an application attempts to read a top of the queue packet, the packet is available in L3 cache to process and there is no additional latency to load data from system memory to cache.

FIG. 5 shows an example descriptor with packet complexity indicator. In this example, field packet buffer address (Addr) 502 can indicate an address in a packet buffer or an index to a buffer identifier in memory that stores a payload of a received packet. Field header buffer address (Addr) 504 can indicate an address in a packet buffer or an index to a buffer identifier in memory that stores a header of a received packet. Field validated fields 506 can indicate whether one or more checksums have been validated. For example, checksums can include TCP or UDP checksums, although other checksums value be validated. Field packet complexity 508 can indicate a complexity of a received packet. For example, the complexity can be identified based on a type of a packet and indicate an expected complexity or time/power needed to process the received packet. Field cache level 510 can indicate a fullness level of a portion of a cache to which DDIO operations can take place or indicate whether to send packets to memory instead of cache. Note that an order and size of fields in a descriptor sent to the NIC or sent by the NIC to a host computing platform can vary. Other fields can be added and not all depicted fields need to be used.

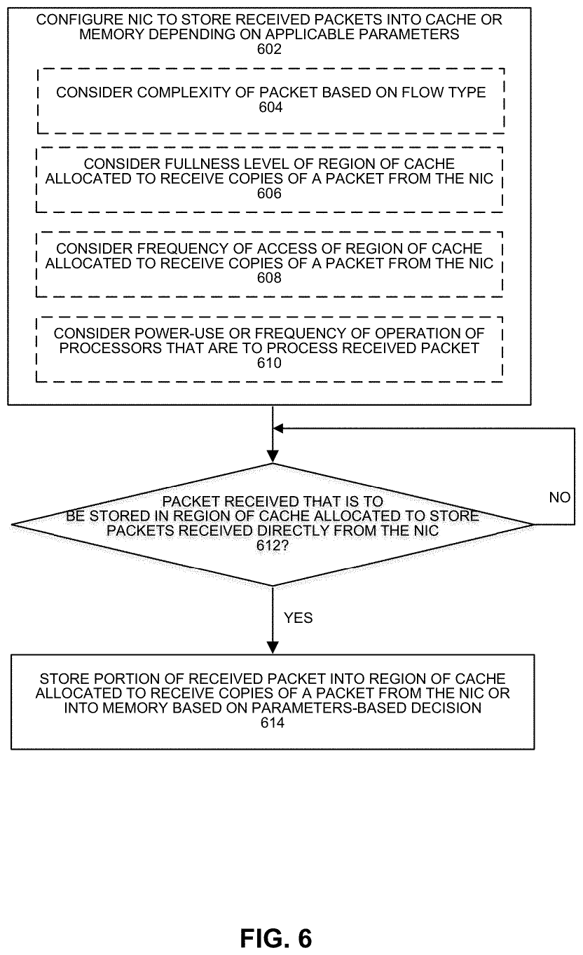

FIG. 6 depicts an example process. At 602, a NIC can be configured to store received packet data into cache or memory depending on applicable parameters. For example, the NIC can be configured to prevent packets at the top of the queue in the cache from being evicted from the cache so that the packets are can be available to be processed. For example, a determination of whether to store a portion of a received packet that is identified to be written to cache, to perform DDIO, can depend on factors such as power level of a core that is to process the packet, packet complexity, fill level of the cache, or frequency of access to a region of the cache allocated to receive packets from the NIC.

For example, the parameters can be based at least on any parameters indicates in any of 604 to 608. For example, at 604, the NIC can be configured to identify packet complexity based on a flow type or header field values in a received packet. For example, at 606, the NIC can be configured with a fullness level of a region of cache that is allocated to store packets directly copied from the NIC. For example, the region of cache can be a region allocated for DDIO copy operations of a portion of a received packet to the cache. For example, at 608, the NIC can be configured with indicator of a level of access to the region of the cache. The level of access can be a number of times the region has been accessed over a period of time. For example, at 610, the NIC can be configured with an indicator of a power level or frequency of operation of one or more cores including a core that is to process the received packet. Other factors can be considered by the NIC in determining whether to store received packet data into cache or memory.

At 612, a determination can be made if a packet is received that is to be stored in a region of the cache that is to receive content of received packets directly from the NIC. For example, the NIC can be configured to store content of some received packets to a region of cache. For example, the region can be allocated for a DDIO-based copy operation from the NIC. The region can receive header and/or payload portions of a received packet. If a packet is received that is to be stored in a region of the cache that is to receive content of received packets directly from the NIC, the process can continue to 614. If a packet is received that is not identified to be directly stored in a region of the cache that is to receive content of received packets directly from the NIC, the process can repeat 612.

At 614, a portion of the received packet can be stored into the region of the cache that is to receive content of received packets directly from the NIC or the memory based on parameters. For example, parameters described with respect to 604 to 610 can be considered. For example, if the region is filled below a threshold level, regardless of the complexity level of the packet and accesses to the region, the NIC can copy the portion of the received packet to the region of the cache. For example, if the region is filled below a threshold level and the complexity level of the packet is low, the NIC can copy the portion of the received packet to the region of the cache. For example, if the region is filled below a threshold level and the complexity level of the packet is low, the NIC can copy the portion of the received packet to the region of the cache and request a reduction in frequency of the core that is to process the packet. For example, if the region is filled below a threshold level and the complexity level of the packet is medium or high, the NIC can copy the portion of the received packet to the region and request an increase in frequency of the core that is to process the packet. For example, if the region is filled beyond a threshold level, the NIC can copy the portion of the received packet to the memory. For example, if the region is filled beyond a threshold level and the complexity level of the packet is low, the NIC can copy the portion of the received packet to the region of the cache. For example, an example of operation of the NIC based on parameters can be as follows, but other factors can be considered (e.g., control plane packet type or data packet).

| Fill level of | | Level of access | | |
|---|---|---|---|---|
| region of cache to | | of region of cache | | |
| receive portion of | | to receive portion | NIC to copy | |
| packet directly | Complexity | of packet directly | received packet to | Core frequency |
| from the NIC | of packet | from the NIC | memory or cache | adjustment |
| At or above | Any | Any | Memory | Possibly request |
| threshold | | | | increase of core |
| | | | | frequency |
| Below | High or | Any | Cache | Possibly request |
| threshold | medium | | | increase of core |
| | | | | frequency |
| Below | Low | Any | Cache | Possibly request |
| threshold | | | | decrease of core |
| | | | | frequency |
| Below | Low | Low | Cache | Possibly request |
| threshold | | | | decrease of core |
| | | | | frequency |

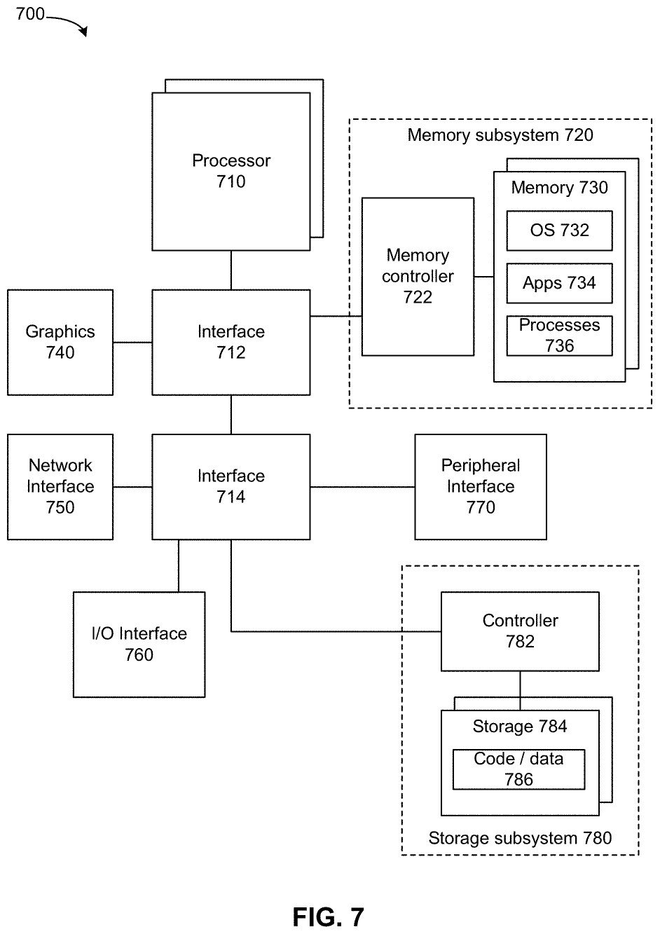

FIG. 7 depicts a system. Various embodiments can be used by system 700 to direct whether a network interface is to store packets to cache or memory based on embodiments described herein. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a fixed function or programmable offload engine that can be accessed or used by a processor 710. For example, an accelerator among accelerators 742 can provide compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. Various embodiments can be used in connection with network interface 750, processor 710, and memory subsystem 720. Various embodiments of network interface 750 use embodiments described herein to receive or transmit timing related signals and provide protection against circuit damage from misconfigured port use while providing acceptable propagation delay.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. Dynamic volatile memory uses refreshing the data stored in the device to maintain state. One example of dynamic volatile memory includes DRAM (Dynamic Random Access Memory), or some variant such as Synchronous DRAM (SDRAM). An example of a volatile memory include a cache. A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), Infinity Fabric (IF), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

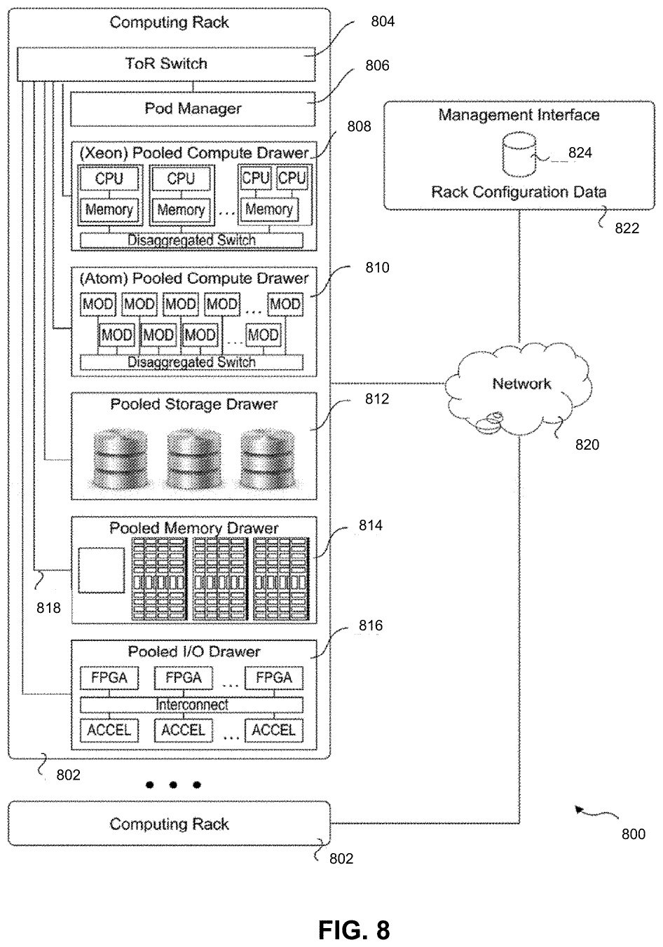

FIG. 8 depicts an environment 800 includes multiple computing racks 802, each including a Top of Rack (ToR) switch 804, a pod manager 806, and a plurality of pooled system drawers. Various embodiments can be used by environment 800 to direct whether a network interface is to store packets to cache or memory based on embodiments described herein. Generally, the pooled system drawers may include pooled compute drawers and pooled storage drawers. Optionally, the pooled system drawers may also include pooled memory drawers and pooled Input/Output (I/O) drawers. In the illustrated embodiment the pooled system drawers include an Intel® Xeon® processor pooled computer drawer 808, and Intel® ATOM™ processor pooled compute drawer 810, a pooled storage drawer 812, a pooled memory drawer 814, and a pooled I/O drawer 816. Each of the pooled system drawers is connected to ToR switch 804 via a high-speed link 818, such as a 40 Gigabit/second (Gb/s) or 100 Gb/s Ethernet link or a 100+Gb/s Silicon Photonics (SiPh) optical link. In one embodiment high-speed link 818 comprises an 800 Gb/s SiPh optical link.

Multiple of the computing racks 802 may be interconnected via their ToR switches 804 (e.g., to a pod-level switch or data center switch), as illustrated by connections to a network 820. In some embodiments, groups of computing racks 802 are managed as separate pods via pod manager(s) 806. In one embodiment, a single pod manager is used to manage all of the racks in the pod. Alternatively, distributed pod managers may be used for pod management operations.

Environment 800 further includes a management interface 822 that is used to manage various aspects of the environment. This includes managing rack configuration, with corresponding parameters stored as rack configuration data 824. In an example, environment 800 can be implemented using interconnected compute sleds of processors, memories, storages, network interfaces, and other components.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nano station (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

Example 1 includes a method comprising: at a network interface: determining whether to store content of a received packet into a cache or into a memory, despite a configuration of the network interface to store content into the cache, based at least in part on a fill level of a region of the cache allocated to receive copies of packet content directly from the network interface, wherein the cache is external to the network interface and storing content of the received packet into the cache or the memory based on the determination.

Example 2 includes any example, wherein determining whether to store content of a received packet into a cache or into a memory, despite a configuration of the network interface to store content into the cache, based at least in part on a fill level of a region of the cache allocated to receive copies of packet content directly from the network interface comprises: determining to store content of the received packet into the memory based at least in part on a fill level of the region of the cache being identified as full or determining to store content of the received packet into the cache based at least in part on a fill level of the region of the cache being identified as not full.

Example 3 includes any example, and includes receiving an indication of the fill level at the network interface from a host computing platform.

Example 4 includes any example, and includes receiving an indication of the fill level at the network interface in a descriptor.

Example 5 includes any example, wherein determining whether to store content of a received packet into a cache or into a memory, despite a configuration of the network interface to store content into the cache, based at least in part on a fill level of a region of the cache allocated to receive copies of packet content directly from the network interface comprises: determining whether to store content of a received packet into a cache or into a memory, despite a configuration of the network interface to store content into the cache, based at least in part on a fill level of a region of the cache allocated to receive copies of packet content directly from the network interface and a power usage level of a core that is to process the content of the received packet.

Example 6 includes any example, wherein determining whether to store content of a received packet into a cache or into a memory, despite a configuration of the network interface to store content into the cache, based at least in part on a fill level of a region of the cache allocated to receive copies of packet content directly from the network interface comprises: determining to store content of the received packet into the memory based at least in part on a power consumption of a core, that is to process the content of the received packet, being indicated as low or determining to store content of the received packet into the cache based at least in part on a power consumption of the core, that is to process the content of the received packet, being indicated as medium or high.

Example 7 includes any example, and includes providing, by the network interface, a packet complexity indicator of the content of the received packet to indicate a level of packet processing to perform on the content of the received packet, wherein a complexity indicated by the packet complexity indicator is to selectively cause adjustment of a power usage level of a processor.

Example 8 includes any example, and includes an interface; circuitry to determine whether to store content of a received packet into a cache or into a memory, at least during a configuration of the network interface to store content directly into the cache, based at least in part on a fill level of a region of the cache allocated to receive copies of packet content directly from the network interface; and circuitry to store content of the received packet into the cache or the memory based on the determination, wherein the cache is external to the network interface.

Example 9 includes any example, wherein the circuitry to determine whether to store content of a received packet into a cache or into a memory, at least during a configuration of the network interface to store content directly into the cache, based at least in part on a fill level of a region of the cache allocated to receive copies of packet content directly from the network interface is to: determine to store content of the received packet into the memory based at least in part on a fill level of the region of the cache being identified as full.

Example 10 includes any example, wherein the circuitry to determine whether to store content of a received packet into a cache or into a memory, at least during a configuration of the network interface to store content directly into the cache, based at least in part on a fill level of a region of the cache allocated to receive copies of packet content directly from the network interface is to receive an indicator of a fill level of a region of the cache allocated to store copies of content of packets received directly from the network interface apparatus.

Example 11 includes any example, wherein the circuitry to determine whether to store content of a received packet into a cache or into a memory, at least during a configuration of the network interface to store content directly into the cache, based at least in part on a fill level of a region of the cache allocated to receive copies of packet content directly from the network interface is to: determine to store content of the received packet into the cache based at least in part on a fill level of the region of the cache being identified as not filled.

Example 12 includes any example, and includes circuitry to indicate a complexity level of content of the received packet to cause adjustment of a power usage level of a processor that is to process the content of the received packet.

Example 13 includes any example, wherein the circuitry to determine whether to store content of a received packet into a cache or into a memory, at least during a configuration of the network interface to store content directly into the cache, based at least in part on a fill level of a region of the cache allocated to receive copies of packet content directly from the network interface is to: receive an indication of a power usage of a processor, that is to process the content of the received packet and determine to store content of the received packet to the memory based on an indication that a power usage of a processor, that is to process the content of the received packet, is low.

Example 14 includes any example, and includes or more of: a server, rack, or data center, wherein the network interface apparatus is coupled to one or more of: the server, rack, or data center.

Example 15 includes any example, wherein the one or more of: the server, rack, or data center comprise the cache, the memory, one or more processors, and a pre-fetcher and wherein the pre-fetcher is to cause copying of content from the memory to the cache based on a prediction of data to be processed from the cache.

Example 16 includes any example, and includes a computing platform comprising one or more processors, a memory, and a cache and a network interface card communicatively coupled to the computing platform, the network interface card to: determine whether to store content of a received packet into a cache or into a memory, independent of a configuration of the network interface to store content directly into the cache, based at least in part on a fill level of a region of the cache allocated to receive copies of packet content directly from the network interface card; and store content of the received packet into the cache or the memory based on the determination, wherein the cache is external to the network interface card.

Example 17 includes any example, wherein to determine whether to store content of a received packet into a cache or into a memory, independent of a configuration of the network interface to store content directly into the cache, based at least in part on a fill level of a region of the cache allocated to receive copies of packet content directly from the network interface card, the network interface card is to: determine to store content of the received packet into the memory based at least in part on a fill level of the region of the cache being identified as full or determine to store content of the received packet into the cache based at least in part on a fill level of the region of the cache being identified as not full.

Example 18 includes any example, wherein to determine whether to store content of a received packet into a cache or into a memory, independent of a configuration of the network interface to store content directly into the cache, based at least in part on a fill level of a region of the cache allocated to receive copies of packet content directly from the network interface card, the network interface card is to: determine whether to store content of a received packet into the cache or into a memory based at least in part on a fill level of a region of the cache allocated to receive copies of packet content directly from the network interface card and a power usage level of a core that is to process the content of the received packet.

Example 19 includes any example, wherein to determine whether to store content of a received packet into a cache or into a memory, independent of a configuration of the network interface to store content directly into the cache, based at least in part on a fill level of a region of the cache allocated to receive copies of packet content directly from the network interface card, the network interface card is to: determine to store content of the received packet into the memory based at least in part on a power consumption of a core, that is to process the content of the received packet, being indicated as low or determine to store content of the received packet into the cache based at least in part on a power consumption of the core, that is to process the content of the received packet, being indicated as medium or high.

Example 20 includes any example, wherein the network interface card is to indicate a complexity level of the content of the received packet to the computing platform to cause adjustment of a power usage level of a processor that is to process the content of the received packet.

What is claimed is:

1. A method comprising:
at a network interface:
determining whether to store content of a received packet into a cache or into a memory, despite a configuration of the network interface to store content into the cache, based at least in part on a fill level of a region of the cache allocated to receive copies of packet content directly from the network interface, wherein the cache is external to the network interface and
storing content of the received packet into the cache or the memory based on the determination.

2. The method of claim 1, wherein determining whether to store content of a received packet into a cache or into a memory, despite a configuration of the network interface to store content into the cache, based at least in part on a fill level of a region of the cache allocated to receive copies of packet content directly from the network interface comprises:
determining to store content of the received packet into the memory based at least in part on a fill level of the region of the cache being identified as full or
determining to store content of the received packet into the cache based at least in part on a fill level of the region of the cache being identified as not full.

3. The method of claim 1, comprising:
receiving an indication of the fill level at the network interface from a host computing platform.

4. The method of claim 3, comprising:
receiving an indication of the fill level at the network interface in a descriptor.

5. The method of claim 1, wherein determining whether to store content of a received packet into a cache or into a memory, despite a configuration of the network interface to store content into the cache, based at least in part on a fill level of a region of the cache allocated to receive copies of packet content directly from the network interface comprises:
determining whether to store content of a received packet into a cache or into a memory, despite a configuration of the network interface to store content into the cache, based at least in part on a fill level of a region of the cache allocated to receive copies of packet content directly from the network interface and a power usage level of a core that is to process the content of the received packet.

6. The method of claim 5, wherein determining whether to store content of a received packet into a cache or into a memory, despite a configuration of the network interface to store content into the cache, based at least in part on a fill level of a region of the cache allocated to receive copies of packet content directly from the network interface comprises:
determining to store content of the received packet into the memory based at least in part on a power consumption of a core, that is to process the content of the received packet, being indicated as low or
determining to store content of the received packet into the cache based at least in part on a power consumption of the core, that is to process the content of the received packet, being indicated as medium or high.

7. The method of claim 1, comprising:
providing, by the network interface, a packet complexity indicator of the content of the received packet to indicate a level of packet processing to perform on the content of the received packet, wherein a complexity indicated by the packet complexity indicator is to selectively cause adjustment of a power usage level of a processor.

8. A network interface apparatus comprising:
an interface;
circuitry to determine whether to store content of a received packet into a cache or into a memory, at least during a configuration of the network interface to store content directly into the cache, based at least in part on a fill level of a region of the cache allocated to receive copies of packet content directly from the network interface; and
circuitry to store content of the received packet into the cache or the memory based on the determination, wherein the cache is external to the network interface.

9. The network interface apparatus of claim 8, wherein the circuitry to determine whether to store content of a received packet into a cache or into a memory, at least during a configuration of the network interface to store content directly into the cache, based at least in part on a fill level of a region of the cache allocated to receive copies of packet content directly from the network interface is to:
determine to store content of the received packet into the memory based at least in part on a fill level of the region of the cache being identified as full.

10. The network interface apparatus of claim 9, wherein the circuitry to determine whether to store content of a received packet into a cache or into a memory, at least during a configuration of the network interface to store content directly into the cache, based at least in part on a fill level of a region of the cache allocated to receive copies of packet content directly from the network interface is to receive an indicator of a fill level of a region of the cache allocated to store copies of content of packets received directly from the network interface apparatus.

11. The network interface apparatus of claim 8, wherein the circuitry to determine whether to store content of a received packet into a cache or into a memory, at least during a configuration of the network interface to store content directly into the cache, based at least in part on a fill level of a region of the cache allocated to receive copies of packet content directly from the network interface is to:
determine to store content of the received packet into the cache based at least in part on a fill level of the region of the cache being identified as not filled.

12. The network interface apparatus of claim 8, comprising:
circuitry to indicate a complexity level of content of the received packet to cause adjustment of a power usage level of a processor that is to process the content of the received packet.

13. The network interface apparatus of claim 8, wherein the circuitry to determine whether to store content of a received packet into a cache or into a memory, at least during a configuration of the network interface to store content directly into the cache, based at least in part on a fill level of a region of the cache allocated to receive copies of packet content directly from the network interface is to:
receive an indication of a power usage of a processor, that is to process the content of the received packet and
determine to store content of the received packet to the memory based on an indication that a power usage of a processor, that is to process the content of the received packet, is low.

14. The network interface apparatus of claim 8, comprising one or more of: a server, rack, or data center, wherein the network interface apparatus is coupled to one or more of: the server, rack, or data center.

15. The network interface apparatus of claim 14, wherein the one or more of: the server, rack, or data center comprise the cache, the memory, one or more processors, and a pre-fetcher and wherein the pre-fetcher is to cause copying of content from the memory to the cache based on a prediction of data to be processed from the cache.

16. A system comprising:
a computing platform comprising one or more processors, a memory, and a cache and
a network interface card communicatively coupled to the computing platform, the network interface card to:
determine whether to store content of a received packet into a cache or into a memory, independent of a configuration of the network interface to store content directly into the cache, based at least in part on a fill level of a region of the cache allocated to receive copies of packet content directly from the network interface card; and
store content of the received packet into the cache or the memory based on the determination, wherein the cache is external to the network interface card.

17. The system of claim 16, wherein to determine whether to store content of a received packet into a cache or into a memory, independent of a configuration of the network interface to store content directly into the cache, based at least in part on a fill level of a region of the cache allocated to receive copies of packet content directly from the network interface card, the network interface card is to:
determine to store content of the received packet into the memory based at least in part on a fill level of the region of the cache being identified as full or
determine to store content of the received packet into the cache based at least in part on a fill level of the region of the cache being identified as not full.

18. The system of claim 16, wherein to determine whether to store content of a received packet into a cache or into a memory, independent of a configuration of the network interface to store content directly into the cache, based at least in part on a fill level of a region of the cache allocated to receive copies of packet content directly from the network interface card, the network interface card is to:
determine whether to store content of a received packet into the cache or into a memory based at least in part on a fill level of a region of the cache allocated to receive copies of packet content directly from the network interface card and a power usage level of a core that is to process the content of the received packet.

19. The system of claim 18, wherein to determine whether to store content of a received packet into a cache or into a memory, independent of a configuration of the network interface to store content directly into the cache, based at least in part on a fill level of a region of the cache allocated to receive copies of packet content directly from the network interface card, the network interface card is to:
determine to store content of the received packet into the memory based at least in part on a power consumption of a core, that is to process the content of the received packet, being indicated as low or
determine to store content of the received packet into the cache based at least in part on a power consumption of the core, that is to process the content of the received packet, being indicated as medium or high.

20. The system of claim 16, wherein the network interface card is to indicate a complexity level of the content of the received packet to the computing platform to cause adjustment of a power usage level of a processor that is to process the content of the received packet.
